(19) United States
(12) Patent Application Publication
(10) Pub. No.: US 2026/0170942 A1
(43) Pub. Date: Jun. 18, 2026

(54) METHOD AND SYSTEM FOR PROCESSING AT LEAST ONE SET OF ALARMS EMITTED IN A COMMUNICATION NETWORK

(71) Applicant: Orange, Issy-les-Moulineaux (FR)

(72) Inventors: Ahmed Triki, CHATILLON CEDEX (FR); Maxime Laye, CHATILLON CEDEX (FR); Bruno Macahdo Carneiro, CHATILLON CEDEX (FR)

(21) Appl. No.: 19/394,327

(22) Filed: Nov. 19, 2025

(30) Foreign Application Priority Data
Nov. 20, 2024 (FR) 2412679

(51) Int. Cl. G08B 29/18; G08B 13/00

(52) U.S. Cl. CPC G08B 29/186; G08B 13/00

(57) ABSTRACT

A method for processing at least one set of alarms emitted in a communication network is described, each alarm including at least one attribute data distinct from a time data, said method including, for each set of alarms, a classification comprising steps implemented by a trained machine learning AI model. This method includes determining, for each alarm and by an encoding module of the AI model, a first vector representation encoding said at least one attribute data, determining, from the first vector representations and by a transformer-encoder of the AI model, at least one output data, and determining, from the at least one output data and by a classification head of the AI model, a classification result of the set of alarms.

### TECHNICAL FIELD

Any and all applications for which a foreign or domestic priority claim is identified in the Application Data Sheet as filed with the present application are hereby incorporated by reference under 37 CFR 1.57.

### TECHNICAL FIELD

The disclosed technology belongs to the general field of communication network diagnosis and maintenance. More specifically, it relates to a method for processing at least one set of alarms emitted in a communication network, as well as a processing system configured to implement said method. The disclosed technology finds a particularly advantageous, although in no way limiting, application in the context of an optical communication network.

### BACKGROUND

The analysis of the alarms emitted in a communication network plays a key role in the management (i.e., detection, diagnosis, maintenance) of the failures in this network. This analysis is traditionally carried out using alarms emitted for a determined duration and once these have been reported to a network management system (NMS).

Conventionally, an alarm corresponds to a signal (or a notification or a message intended to be stored in a register in the form of a data file, called “log”) emitted by an entity belonging to a communication network. Such an entity typically includes hardware and/or software means to implement a functionality within said network, it being understood that in the event of a failure (i.e. an operating problem), said functionality can no longer be implemented.

Particularly, an alarm may include one or more attribute data (i.e. one or more data specific to said alarm), distributed in as many fields of the alarm, such as for example:
a type of the alarm, which informs on the nature of the failure. This field generally appears as a string of characters or alphanumeric code. A short list of possible alarm types is provided by each network equipment manufacturer,
an indicator representative of a severity level of the alarm (e.g., critical, major, minor, warning, etc.),
a type of a communication network entity that emitted the alarm (e.g., hardware, equipment, logical or physical port, etc.),
an identifier of a communication network entity that emitted the alarm,
an indicator representative of the network layer from which the alarm was emitted,
a time data (e.g., a timestamp indicating the date and time the alarm was emitted by a network entity, a timestamp indicating the date and time the alarm was received by a system NMS, a duration of transmission of an alarm from an emitting entity to a system NMS, etc.).

As the current communication networks continue to expand, it has become increasingly difficult to analyze the failures impacting the services, functionalities and equipment attached to these networks. Indeed, the more networks expand, the greater the number of alarms generated in the event of failures. This further complicates the management of the failures and more specifically the diagnostic task, which comprises in particular the identification of a failure/alarm at the origin of other possible failures/alarms (also known as “root cause”).

This problem is further compounded by the fact that some alarms may be redundant and/or related to the same root cause. It is also possible to have false alarms, or insignificant alarms.

One way, at least theoretically, to overcome this problem is to perform specific processing based on the alarms reported to a system NMS. This processing consists in grouping the alarms into different clusters so that the alarms contained in the same cluster are “similar” in the sense that they were all triggered by the same root cause (the alarm associated with the root cause also being contained in the cluster).

In practice, this clustering processing was initially performed manually by experts based on their business knowledge. However, this approach is very time-consuming and tedious, and is now tending to be replaced by automated methods.

Some automated methods consist in transforming the expert knowledge into business rules implemented in software. These methods are nonetheless defective in that the regular updates of the business rules, in particular for the purposes of adapting to the various developments of the network (deployment of new equipment, deployment of new services, etc.), also require significant time and resource investment.

Other more recent automated methods implement statistical or artificial intelligence techniques, in particular machine learning, which rely essentially on the time data contained in the alarms as well as on the assumption that there is perfect time synchronization between the network entities likely to emit alarms. However, on the one hand, such assumption cannot be guaranteed and, on the other hand, it can lead to the formation of invalid clusters when it is deficient.

In the present description, “invalid cluster” refers to a cluster including at least one intruder alarm (i.e., an alarm whose root cause is distinct from the one associated with the other alarms in the cluster) and/or in which at least one expected alarm is missing (i.e., an alarm whose root cause is identical to the one associated with the other alarms in the cluster).

Indeed, and by way of non-limiting examples, such a synchronization fault may have a direct impact on the processing of alarms related to distinct root causes and associated with failures occurring simultaneously or reported to the system NMS over a long duration (risk of partial or total time overlap between clusters), or on the processing of alarms whose emissions are temporally distant from the other alarms related to the same root cause (risk of generation of dissociated clusters while they should form only one cluster).

### SUMMARY

The disclosed technology aims to overcome all or part of the drawbacks of other approaches, in particular those set out above, by proposing a solution that allows classifying the alarms emitted in a communication network so as to be able to obtain valid clusters in an automated and more efficient manner than the solutions of the state of the art.

To this end, and according to a first aspect, the disclosed technology relates to a method for processing at least one set of alarms emitted in a communication network, each alarm including at least one attribute data distinct from a time data, said method including, for each set of alarms, a phase called “classification” phase comprising steps implemented by a trained machine learning model, called “AI model”, including:
determining, for each alarm of said at least one set of alarms, and by an encoding module of the AI model, a first vector representation encoding said at least one attribute data, so as to obtain a set of first vector representations,
determining, from said set of first vector representations and by a transformer-encoder of the AI model, at least one second vector representation for each first vector representation,
determining, from said at least one second vector representation and by a classification head of the AI model, a classification result of said set of alarms.

Thus, the processing method according to the disclosed technology takes advantage, via the AI model, of the attribute data to achieve an automated classification of the alarms. This approach is particularly advantageous in comparison with the solutions of the state of the art in that these attribute data are characteristic of said alarms while being distinct from time data.

It follows from these considerations that the alarms are considered as information units (also called “tokens”) between which it is possible to establish correlations through the exploitation of the attribute data by the AI model.

To this end, the AI model is inspired by models used in the automated natural language processing (NLP), such as the BERT (Bidirectional Encoder Representations from Transformers) model, so as to be able to create “semantic” links between the alarms contained in said at least one set of alarms.

It is important to note that the term “semantic”, with regard to the links between alarms, derives from the usual terminology used when using NLP models. In this sense, and although the information units namely the alarms do not correspond to a language spoken by humans, they can nevertheless be seen as “words” interpreted and analyzed by the AI model to draw semantic links (i.e. correlations) therefrom. The set of possible words constitutes a vocabulary representative of the alarms that can be emitted in the communication network, and whose richness derives from the attribute data associated with them. Furthermore as a result, if a valid cluster is considered, the alarms grouped within it form a “sentence” (i.e., a combination of words) that has meaning with regard to said semantics.

Since no time data is taken into account by the AI model, the semantics of the vocabulary formed by the alarms does not depend on such time data, but relies exclusively on the attribute data. As already mentioned above, this is a fundamental difference from the methods of the state of the art which, with a view to grouping alarms into clusters, rely essentially on this type of time data to classify the alarms.

In particular modes of implementation, the treatment method may further include one or more of the following characteristics, taken separately or in all technically possible combinations.

In particular modes of implementation, said at least one attribute data includes one or more attribute data among:
a type of the alarm,
an indicator representative of a severity level of the alarm,
a type of a communication network entity that emitted the alarm,
an identifier of a communication network entity that emitted the alarm,
an indicator representative of the network layer from which the alarm was emitted.

In particular modes of implementation:
said at least one set of alarms includes a plurality of sets of alarms, each set of alarms corresponding to a cluster having been generated prior to the implementation of the method from a superset of alarms emitted in at least part of the communication network during a determined duration, and each cluster being associated with an alarm corresponding to an event in the communication network at the origin of the emission of the alarms of said cluster, and
the classification result corresponds to an indication of validity or absence of validity of said cluster, which is determined by the implementation of the classification phase for each cluster, the absence of validity being defined by a presence in said cluster of at least one intruder alarm, and/or an absence in said cluster of at least one expected alarm.

In particular modes of implementation, said indication of validity or absence of validity of said cluster is a binary classification result.

In particular modes of implementation, the determination of the classification result includes an identification of at least one intruder alarm in said cluster.

In particular modes of implementation, said method further includes, if at least one intruder alarm has been detected in each among a plurality of clusters, a phase called “correction” phase comprising steps of:
updating the invalid clusters by replacing, in each invalid cluster, at least one intruder alarm identified in said invalid cluster with at least one other intruder alarm identified in another invalid cluster,
executing, by the AI model, the classification phase for each of the updated clusters, said correction phase being iterated until a stopping criterion is satisfied.

In particular modes of implementation, the AI model was trained using a masked language learning technique.

In particular modes of implementation:
said at least one set of alarms consists of a single set of alarms corresponding to alarms emitted in at least part of the communication network for a determined duration,
said at least one output data of the transformer-encoder includes, for each first vector representation, a second contextualized vector representation, and
the AI model has been trained using a contrastive learning technique so that the classification result includes, for each second vector representation, a third vector representation, said third vector representations being representative of a similarity of the alarms of said single set of alarms.

In particular modes of implementation, said method further includes a step of grouping the alarms of said single set of alarms into clusters from said third vector representations.

In particular modes of implementation, said method further includes:
once the correction phase is completed and for each updated cluster, a step of determining an alarm belonging to said cluster and corresponding to an event in the communication network at the origin of the emission of the other alarms of said cluster;
once the grouping step is completed and for each cluster, a step of determining an alarm corresponding to an event in the communication network at the origin of the emission of the alarms of said cluster.

In particular modes of implementation, the communication network is an optical communication network or a CAN-type network deployed in a transport vehicle.

According to a second aspect, the disclosed technology relates to a computer program including instructions for the implementation of a data processing method according to the disclosed technology when said computer program is executed by a computer.

This program may use any programming language, and be in the form of source code, object code or intermediate code between source code and object code, such as in a partially compiled form or in any other desirable form.

According to a third aspect, the disclosed technology relates to a computer-readable information or recording medium on which a computer program according to the disclosed technology is recorded.

The information or recording medium may be any entity or device capable of storing the program. For example, the medium may include a storage means such as a ROM, for example a CD ROM or a microelectronic circuit ROM, or a magnetic recording means for example a hard disk.

Furthermore, the information or recording medium may be a transmissible medium such as an electrical or optical signal, which may be conveyed via an electrical or optical cable, by radio or by other means. The program according to the disclosed technology may particularly be downloaded from an Internet-type network.

Alternatively, the information or recording medium may be an integrated circuit in which the program is incorporated, the circuit being adapted to execute or to be used in the execution of the method in question.

According to a fourth aspect, the disclosed technology relates to a device for processing at least one set of alarm messages emitted in a communication network, called “set of alarms”, each alarm message including at least one information characteristic of the alarm associated with said alarm message, said processing device including means configured to implement a processing method according to the disclosed technology.

### BRIEF DESCRIPTION OF THE DRAWINGS

Other characteristics and advantages of the disclosed technology will emerge from the description given below, with reference to the appended drawings which illustrate one exemplary embodiment thereof without any limitation. In the figures:

FIG. 1 schematically represents, in its environment, one particular embodiment of an alarm processing device according to the disclosed technology;

FIG. 2 schematically represents one example of hardware architecture of the processing device of FIG. 1;

FIG. 3 represents, in the form of a flowchart, the main steps of a processing method implemented by the device of FIG. 2;

FIG. 4 schematically represents a general configuration of an AI model implemented by the processing device of FIG. 1 to execute the processing method of FIG. 3;

FIG. 5 represents, in the form of a flowchart, a first particular mode of the processing method of FIG. 3;

FIG. 6 schematically represents one example of configuration of the AI model for the implementation of the first particular mode of FIG. 5;

FIG. 7 represents, in the form of a flowchart, a second particular mode of the processing method of FIG. 3;

FIG. 8 schematically represents one example of configuration of the AI model for the implementation of the second particular mode of FIG. 7;

FIG. 9 represents, in the form of a flowchart, a third particular mode of the processing method of FIG. 3.

FIG. 10 schematically represents one example of grouping of seven alarms during the implementation of the third particular mode of FIG. 9.

### DETAILED DESCRIPTION

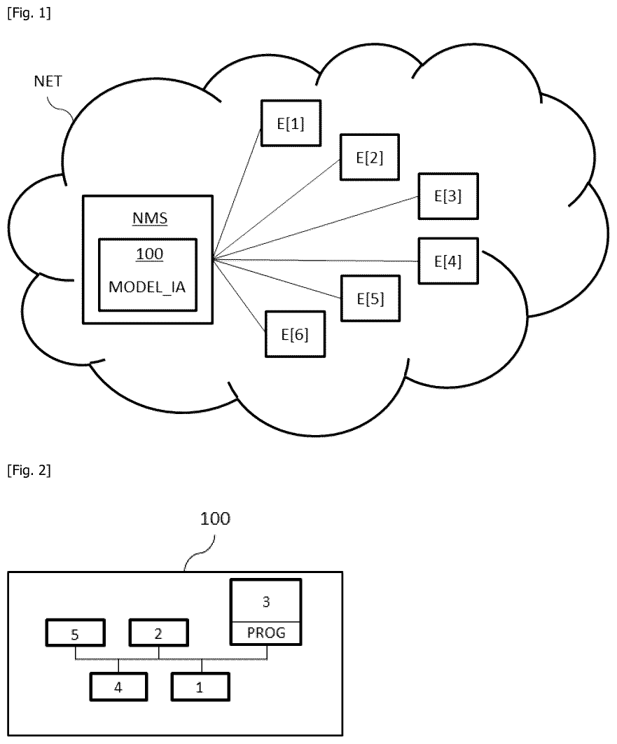

FIG. 1 schematically represents, in its environment, one particular embodiment of an alarm processing device 100 according to the disclosed technology.

As illustrated in FIG. 1, the device 100 is integrated into a network management system (NMS) belonging to a network NET.

For the remainder of the description, it is considered, in a non-limiting manner, that the network NET is an optical transport network, the data exchanged within the network NET being done so by means of the OTN (Optical Transport Network) protocol.

The fact of considering an optical transport network however does not constitute a limitation of the disclosed technology, this conclusion also applying to the scope of this network. Generally, any type of network in which alarms can be emitted by entities belonging to said network can be envisaged, provided that each of said alarms includes at least one attribute data distinct from a time data as described in more detail later. By way of illustration, a CAN (Control Area Network) type network deployed in a transport vehicle, such as a car, can be envisaged as an alternative to an optical transport network.

The management system NMS is in particular configured to receive alarms emitted by entities of said network NET. The alarms are received and stored in the form of log files in a register, each log file including a plurality of fields containing attribute data specific to said alarms.

Each of said entities is configured in hardware and/or software to perform a determined function within the network NET (this function depending in particular on the entity belonging to the transport plane or to the service plane or to the control plane of the network NET), but also to emit an alarm when a failure (an incident) prevents the performance of this functionality.

In the present embodiment where the network NET is an optical transport network, an entity corresponds for example to an optical transceiver, an optical amplifier, an optical filter, an optical commutator, an optical switch, a physical or software port, a network layer, etc.

In the example of FIG. 1, six entities E[1], . . . , E[6] are represented for illustrative purposes. However, it will be clear that no limitation is attached the number of entities that can belong to the network NET.

For the remainder of the description, the notation A[i] (i being an integer index varying between 1 and 6) is also adopted to designate an alarm emitted by the entity E[i]. The use of the single index “i” implies here that, for reasons of simplification of the description, the emission of a single alarm A[i] by the entity E[i] is considered. It is however understood that these provisions are not limiting the disclosed technology and that, of course, each entity E[i] can emit a plurality of alarms.

As mentioned above, each alarm A[i] emitted in the network NET includes at least one attribute data DATA_ATT[i,j] (j being an integer index comprised between 1 and 5) distinct from a time data, such as for example:
DATA_ATT[i,1]: a type of the alarm A[i], which informs on the nature of the failure. This field generally appears as a string of characters or alphanumeric code. A short list of possible alarm types is provided by each network equipment manufacturer,
DATA_ATT[i,2]: an indicator representative of a severity level of the alarm A[i] (for example critical, major, minor, warning, etc.),
DATA_ATT[i,3]: a type of the entity E[i] that has emitted the alarm A[i],
DATA_ATT[i,4]: an identifier of the entity E[i] that has emitted the alarm A[i],
DATA_ATT[i,5]: an indicator representative of the network layer from which the alarm A[i] was emitted.

No limitation is attached to the number of attribute data DATA_ATT[i,j] that can be envisaged for each alarm A[i]. Preferably, each alarm A[i] includes at least one attribute data DATA_ATT[i,1] corresponding to the type of the alarm A[i], as well as possibly other attribute data DATA_ATT[i,j] with j different from 1.

In practice, each alarm A[i] also includes one or more time data among the following non-limiting list:
a timestamp indicating the date and time the alarm A[i] was emitted by the entity E[i],
a timestamp indicating the date and time the alarm A[i] was received by the system NMS,
a duration of transmission the alarm A[i] from the entity E[i] to the system NMS.

In any event, and advantageously compared to the state of the art, such time data are not used to implement the disclosed technology, as explained in detail later.

It should be noted that the system NMS is described here as belonging to the network NET. These provisions are however not limiting the disclosed technology, and nothing precludes envisaging that the system NMS is located in another network, such as for example a cloud network.

Following similar considerations, considering that the alarm processing device 100 is integrated into the system NMS constitutes only one variant of implementation of the disclosed technology. Particularly, the device 100 may be external to the system NMS and located or not in the network NET, regardless of whether said system NMS is located or not in the network NET.

The device 100 is configured to carry out, from at least one set of alarms C[k] (k being an integer index designating the number of sets of alarms considered), processing making it possible in particular to obtain a classification result for said at least one set C[k], by implementing a processing method according to the disclosed technology.

It should be noted that said at least one set C[k] can take different forms.

For example, said at least one set C[k] can consist of a single set of alarms, denoted C[0], corresponding to alarms (e.g., all the alarms) emitted in at least part of the network NET (or possibly the entire network NET, i.e. by all the entities E[1], . . . , E[6]) for a determined duration.

Alternatively, said at least one set of alarms C[k] includes a plurality of sets of alarms C[1], . . . , C[K] (K being an integer strictly greater than 1), each set C[k] (k being comprised between 1 and K) corresponding to a cluster having been generated prior to the implementation of the processing method from a superset of alarms emitted in at least part of the network NET (or possibly the entire network NET, i.e. by all the entities E[1], . . . , E[6]) during a determined duration (example: said superset corresponds to said single set of alarms C[0] mentioned in the previous example). According to this alternative, each cluster is associated with a root cause specific to it (i.e. to an alarm corresponding to an event in the network NET at the origin of the emission of the alarms of said cluster).

These aspects related to the form taken by said at least one set C[k] are addressed in more detail later for the description of particular embodiments of the disclosed technology.

It is further noted that, regardless of the fact that said at least one set C[k] includes one or more sets of alarms, the disclosed technology is not limited by the duration taken into account to consider alarm emissions intended to form said at least one set of alarms C[k]. For example, this duration may be chosen so as to guarantee a compromise between, on the one hand, a limitation of the computing and memory resources necessary for the implementation of the disclosed technology and, on the other hand, the consideration of a sufficiently large number of alarms to allow differentiating the different failures at the origin of said alarms (example: duration of 24 hours).

FIG. 2 schematically represents one example of hardware architecture of the processing device 100 of FIG. 1.

As illustrated in FIG. 2, the device 100 has the hardware architecture of a computer. Thus, the device 100 includes, in particular, a processor 1, a random access memory 2, a read-only memory 3 and a non-volatile memory 4. It also has communication means 5.

The read-only memory 3 of the device 100 constitutes a recording medium in accordance with the disclosed technology, readable by the processor 1 and on which a computer program PROG in accordance with the disclosed technology is recorded, including instructions for the execution of steps of the processing method.

The program PROG defines functional modules of the device 100, which rely on or control the hardware elements 1 to 5 of the device 100 cited above. These functional modules define in particular a trained machine learning model, called “AI model” (and also noted “MODEL_IA” in the figures), and described in more detail below.

The communication means 5 allow the device 100 to exchange (transmit/receive) data with hardware and/or software components of the system NMS as well as possibly with one or more other entities of the NSM network, in particular to access (obtain) alarms that have been emitted. For this purpose, these communication means 5 rely on a communication interface, which may be wired or wireless, using any communication protocol known to those skilled in the art.

As mentioned above, the implementation of the processing method relies on the AI model implemented by the device 100. In its general principle, the AI model is configured to exploit the attribute data DATA_ATT[i,j] associated with the alarms A[i] contained in said at least one set C[k]. More specifically, a main idea of the disclosed technology lies in considering the alarms A[i] as information units (also called “tokens”) between which it is possible to establish correlations through the exploitation of the attribute data DATA_ATT[i,j] by the AI model.

To this end, the AI model is inspired by models used in the automated natural language processing (or NLP), such as typically the BERT (Bidirectional Encoder Representations from Transformers) model, so as to be able to create “semantic” links between the alarms A[i] contained in said at least one set C[k].

It is important to note that the term “semantics”, as regards the links between alarms A[i], derives from the usual terminology used when using NLP models. In this sense, and although the information units namely the alarms A[i] do not correspond to a language spoken by humans, they can nevertheless be seen as “words” interpreted and analyzed by the AI model to derive semantic links (i.e. correlations). The set of possible words constitutes a vocabulary representative of the alarms A[i] that can be emitted in the network NET, and whose richness derives from the attribute data DATA_ATT[i,j] associated with them.

Another important point to be noted is that the processing by the AI model of the alarms contained in said at least one set C[k] is independent of the time data possibly contained in said alarms A[i]. In other words, the semantics of the vocabulary formed by the alarms A[i] does not depend on the time order in which said alarms A[i] were emitted, but is based exclusively on the attribute data DATA_ATT[i,j]. This is a fundamental difference with the methods of the state of the art which, with a view to grouping alarms into clusters, rely essentially on this type of time data to classify the alarms.

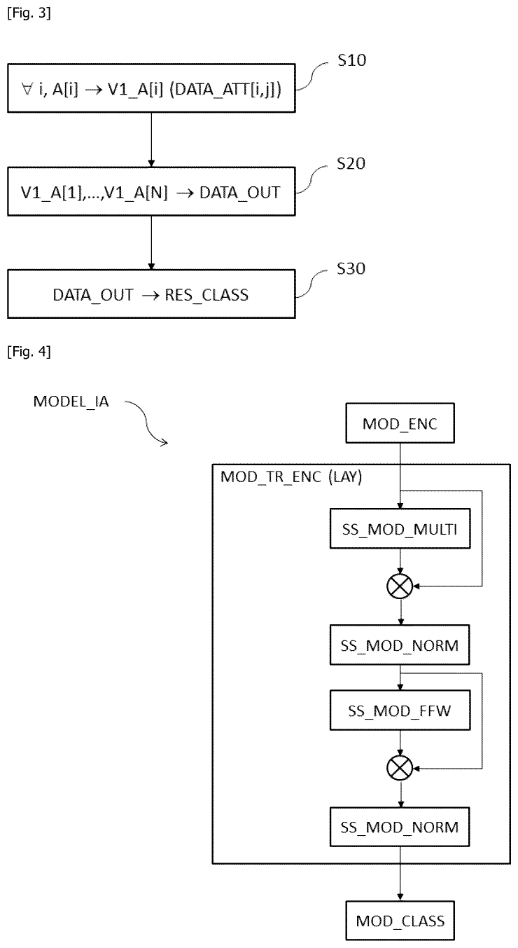

FIG. 3 represents, in the form of a flowchart, the main steps of the processing method implemented by the device 100 of FIG. 2 for each set of alarms C[k], and more particularly by the AI model implemented by said device 100. These main steps correspond to a phase called “classification” phase.

FIG. 4 schematically represents a general configuration of the AI model implemented by the device 100 to execute the method of FIG. 3.

As illustrated in FIG. 3, the classification phase associated with a set C[k] firstly includes a step S10 of determining, for each alarm A[i] of said set C[k] and by an encoding module MOD_ENC of the AI model, a first vector representation V1_A[i] encoding said at least one attribute data DATA_ATT[i,j] of said alarm A[i].

Said first vector representation V1_A[i] corresponds to a representation of the alarm A[i] in a representation space SP_R which is such that each of its dimensions is representative of an attribute data DATA_ATT[i,j]. In other words, the value of a component of said first vector representation V1_A[i] corresponds to the proportion of the attribute data DATA_ATT[i,j] associated with this component in said representation space SP_R.

In accordance with what was mentioned above concerning the analogy with the NLP models, the representation space SP_R considered here for the first vector representations V1_A[i] can then be interpreted as a “semantic” space of the vocabulary formed by the alarms A[i] when they are seen as “words”, each of the dimensions of said representation space SP_R corresponding to a semantic concept in said vocabulary.

In practice, to carry out the encoding of an alarm A[i] of the set C[k], each of the attribute data DATA_ATT[i,j] is encoded in the representation space SP_R according to the dimension that corresponds to it. The combination of these encodings of the attribute data DATA_ATT[i,j] forms the encoding of said alarm A[i].

For illustrative purposes only, one example of an alarm set C[k] including three alarms A[1], A[2] and A[3] is considered.

In this example, each alarm A[i] in the set C[k] includes three attribute data: DATA_ATT[i,1], DATA_ATT[i,2] and DATA_ATT[i,3]. Consequently, the representation space SP_R has three dimensions here.

More specifically, the alarm A[1] includes:
an attribute data DATA_ATT[1,1] corresponding to an alarm type “T-ES-PCST” whose encoding in the representation space SP_R provides the value 42;
an attribute data DATA_ATT[1,2] corresponding to a severity level “major” whose encoding in the representation space SP_R provides the value 2;
an attribute data DATA_ATT[1,3] corresponding to a “transponder” type of the entity E[1] whose encoding in the representation space SP_R provides the value 4.

The alarm A[2] includes:
an attribute data DATA_ATT[2,1] corresponding to an alarm type “LOS” whose encoding in the representation space SP_R provides the value 19;
an attribute data DATA_ATT[2,2] corresponding to a severity level “major” whose encoding in the representation space SP_R provides the value 2;
an attribute data DATA_ATT[2,3] corresponding to a “transponder” (or “amplifier”, or “multiplexer”) type of the entity E[2] whose encoding in the representation space SP_R provides the value 1.

The alarm A[3] includes:
an attribute data DATA_ATT[3,1] corresponding to an alarm type “REPLUNITMISS” whose encoding in the representation space SP_R provides the value 211;
an attribute data DATA_ATT[3,2] corresponding to a severity level “critical” whose encoding in the representation space SP_R provides the value 4;
an attribute data DATA_ATT[3,3] corresponding to a “programmable card” type of the entity E[3] whose encoding in the representation space SP_R provides the value 15.

Ultimately, in this example, three first vector representations V1_A[1], V1_A[2] and V1_A[3] are obtained at the output of the encoding module MOD_ENC of the AI model, where:

$$\begin{matrix}- V1\_A [ 1 ] = ( 42 , 2 , 4 ) ; \\ - V1\_A [ 2 ] = ( 19 , 2 , 1 ) ; \\ - V1\_A [ 3 ] = ( 211 , 4 , 15 ) .\end{matrix}$$

These first three vector representations V1_A[1], V1_A[2] and V1_A[3] can for example be grouped to correspond respectively to the columns of a matrix. In this example, said matrix is of dimension 3×3, because the representation space SP_R is of dimension equal to three and three alarms A[1], A[2] and A[3]) are considered. More generally, if the representation space SP_R is of dimension equal to M and if N alarms A[1], . . . , A[N] are considered, the matrix associated with the set C[k] containing said alarms is of dimension N×M.

It should be noted that, in a more specific mode of implementation, the alarms of a set C[k] having the same first vector representation are only taken into account once. In other words, once said first vector representations have been determined, it is possible to envisage a step of filtering them in order to avoid redundancies.

It should also be noted that the encoding module MOD_ENC can possibly be configured to carry out, in addition to the encoding of the alarms A[i] in the representation space SP_R and by means of an appropriate sub-module (not represented in the figures), an additional encoding of the first vector representations V1_A[i]. This additional encoding allows adapting the dimension of each of said first vector representations V1_A[i] to a specific format expected at the input of a transformer-encoder type module described in detail below. This is an embedding operation in a latent space SP_L whose implementation details are known to those skilled in the art, so they are not described further here. In any event, and for reasons of simplification of the description, it is now considered for the following that said first vector representations V1_A[i] provided as output from the encoding module MOD_ENC are:
said embeddings in said latent space SP_L if said additional encoding is executed, or
said representations in the representation space SP_R if said additional encoding is not executed.

Subsequently, and as illustrated in FIG. 3, the classification phase associated with a set C[k] includes a step S20 of determining, from the first vector representations V1_A[i] determined during step S10 and by a transformer-encoder MOD_TR_ENC of the AI model, at least one output data DATA_OUT.

The first vector representations V1_A[i] thus form a sequence provided as input to the transformer-encoder MOD_TR_ENC, the order within this sequence having no importance within the meaning of the disclosed technology. For example, if the first vector representations V1_A[i] are grouped in the form of a matrix, as described above, the order in which the columns of this matrix are taken into account is irrelevant.

“Transformer-encoder” refers only to the sole part called “encoder” part of a transformer-type model, it being understood that, conventionally, such a transformer-type model also includes a part called “decoder” part.

The configuration of the transformer-encoder MOD_TR_ENC is of a type known per se. Thus, in FIG. 4, a layer LAY of said transformer-encoder MOD_TR_ENC is represented, it being understood that the number of layers is not a limitation of the disclosed technology.

This layer LAY includes a sub-module SS_MOD_MULTI configured to receive the first vector representations V1_A[i] and implement a multi-head attention mechanism. As is well known, the multi-head attention mechanism allows the AI model to evaluate the relative importance of the first vector representations V1_A[i] within the input sequence.

The layer LAY also includes a sub-module SS_MOD_FFW placed after the sub-module SS_MOD_MULTI (in the order in which the data are processed within the transformer-encoder MOD_TR_ENC) and configured to implement a FeedForward Neural Network.

Finally, between the sub-module SS_MOD_MULTI and the sub-module SS_MOD_FFW, as well as at the output of said sub-module SS_MOD_FFW, the layer LAY includes sub-modules SS_MOD_NORM configured to implement normalization layers able to maintain the values of the processed data within ranges representative of a standard distribution.

Said at least one output data DATA_OUT may take different forms depending on the classification sought, as described below in relation to more specific embodiments. In any event, and in a manner known per se, said at least one output data DATA_OUT corresponds to at least one contextual vector representation relating to the input sequence formed by the first vector representations V1_A[i].

The term “contextual” here refers to the fact that the attribute data DATA_ATT[i,j] associated with the alarms A[i] provide context information to determine whether there is a link between said alarms A[i], which is the case if alarms are associated with the same root cause.

Finally, and as illustrated in FIG. 3, the classification phase associated with a set C[k] includes a step S30 of determining, from said at least one output data DATA_OUT and by a classification head MOD_CLASS of the AI model, a classification result RES_CLASS of said set C[k].

The classification result RES_CLASS provides information characterizing:
the ability to generate valid clusters from the set C[k], assuming that said set C[k] is the set C[0], or
the validity or absence of validity of the set C[k] assuming that said set C[k] corresponds to a cluster having been generated prior to the implementation of the processing method.

Furthermore, the information provided by such a classification result RES_CLASS is advantageous in that it allows envisaging the implementation of subsequent alarm processing to ensure that valid clusters are obtained, whether or not these have been predetermined before the implementation of the classification phase.

To do so, different configurations of the classification head MOD_CLASS can be envisaged through three particular modes of implementation of the processing method respectively referenced: particular mode A, particular mode B, particular mode C, and which will now be described.

### Particular Mode A

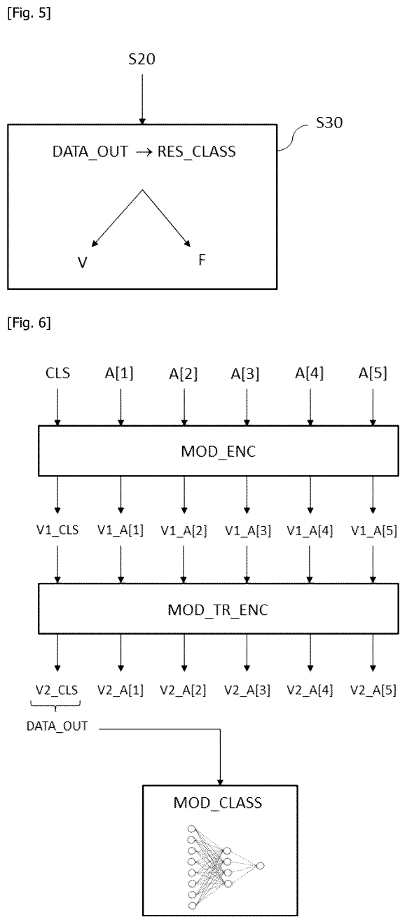

FIG. 5 represents, in the form of a flowchart, the particular mode A of the processing method of FIG. 3.

In the particular mode A, it is considered that said at least one set of alarms C[k] includes a plurality of sets of alarms C[1], . . . , C[K] (K being an integer strictly greater than 1), each set C[k] (k being comprised between 1 and K) corresponding to a cluster having been generated prior to the implementation of the processing method from a superset of alarms emitted in the network NET during a determined duration (example: said superset corresponds to said single set of alarms C[0] mentioned above).

Moreover, in the particular mode A, the generation of the clusters C[1], . . . , C[K] was performed so that each cluster C[k] is associated with a root cause specific to it (i.e. with an alarm corresponding to an event in the network NET at the origin of the emission of the alarms of said cluster). Any method known to those skilled in the art for generating said clusters C[1], . . . , C[K] in this way may be envisaged, the choice of a particular method constituting only a variant of implementation of the disclosed technology.

Furthermore, in the present particular mode A, the classification result RES_CLASS determined for a cluster C[k] corresponds to an indication of validity or absence of validity of the cluster C[k], it being understood that, as already mentioned, the absence of validity is defined by a presence in said cluster C[k] of at least one intruder alarm and/or an absence in said cluster C[k] of at least one expected alarm.

More specifically, in the particular mode A and as illustrated in FIG. 5, said indication of validity or absence of validity of said cluster is a binary classification result, which may for example take the values “V” (for “True”) or “F” (for “False”) for a valid cluster or an invalid cluster respectively.

It should be noted that if a cluster C[k] is determined to be invalid (i.e. RES_CLASS=F), this does not identify the specific reason for this absence of validity (e.g.: presence of an intruder alarm). These aspects correspond to the implementation of the particular mode B, as described later.

FIG. 6 schematically represents one example of configuration of the AI model for the implementation of the particular mode A.

In the example of FIG. 6, and for illustrative purposes, a cluster C[k] including five alarms A[1], . . . , A[5] is considered. These five alarms A[1], . . . , A[5] are provided as input to the AI model for the execution of steps S10, S20 and S30.

In this example of FIG. 6, in addition to the alarms A[1], . . . , A[5], a Classify Token “CLS” is also provided as input to the AI model. In a manner known per se, said classify token CLS is a special token used in the machine learning models, particularly those based on a transformer-type architecture, to provide a representation of all the other elements provided as input to the AI model, in this case the alarms A[1], . . . , A[5]. Said classify token CLS can therefore be seen here as a fictitious alarm representative of the alarms A[1], . . . , A[5] and is conventionally placed first, i.e. upstream of the sequence of alarms A[1], . . . , A[5], as illustrated in FIG. 6.

Therefore, the encoding module MOD_ENC determines for each alarm A[i] a first vector representation V1_A[i], but also a first vector representation V1_CLS for the classify token CLS. The transformer-encoder MOD_TR_ENC determines, for each of said first vector representations V1_A[i], V1_CLS, second vector representations V2_A[i], V2_CLS.

Subsequently, in the example of FIG. 6, said at least one output data DATA_OUT provided as output from the transformer-encoder MOD_TR_ENC consists of the second representation V2_CLS only.

This output data V2_CLS is provided as input to the classification head MOD_CLASS which, in the example of FIG. 6, is a multi-layer perceptron (MLP) type neural network including a single output neuron corresponding to the binary classification result RES_CLASS (i.e. V or F).

It should be noted that the fact of using a classify token CLS, as described with reference to FIG. 6, constitutes only one variant of implementation of the disclosed technology, other variants can be envisaged. For example, once the second vector representations V2_A[i] have been determined by the transformer-encoder MOD_TR_ENC, a grouping of said vector representations V2_A[i] can be envisaged, for example by means of an averaging type function, so as to generate a general vector representation of said vector representations V2_A[i]. This general vector representation can then be provided as input to the classification head MOD_CLASS, again configured according to a multi-layer perceptron “MLP” type neural network including a single output neuron corresponding to the binary classification result RES_CLASS (i.e. V or F).

As regards the training of the AI model within the framework of the particular mode A, it can be carried out according to any method known to those skilled in the art, the choice of a particular method constituting only a variant of implementation of the disclosed technology. For example, it may be a supervised training (i.e. use of samples of clusters which are known to be valid or invalid, and to which corresponding labels are attached) coupled to a masked language learning “MLM” (acronym for Masked Language Modeling) method.

### Particular Mode B

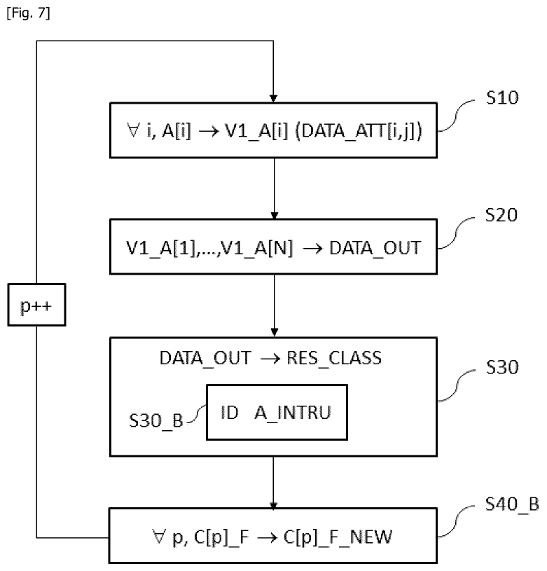

FIG. 7 represents, in the form of a flowchart, the particular mode B of the processing method of FIG. 3.

In the particular mode B, it is considered that said at least one set of alarms C[k] includes a plurality of sets of alarms C[1], . . . , C[K] (K being an integer strictly greater than 1), each set C[k] (k being comprised between 1 and K) corresponding to a cluster having been generated prior to the implementation of the processing method from a superset of alarms emitted in the network NET during a determined duration (example: said superset corresponds to said single set of alarms C[0] mentioned above).

Moreover, in the particular mode B, the generation of the clusters C[1], . . . , C[K] was performed so that each cluster C[k] is associated with a root cause specific to it (i.e. to an alarm corresponding to an event in the network NET at the origin of the emission of the alarms of said cluster). Any method known to those skilled in the art for generating said clusters C[1], . . . , C[K] in this way can be envisaged, the choice of a particular method constituting only a variant of implementation of the disclosed technology.

Furthermore, in the present particular mode B and as illustrated by FIG. 7, said step S30 of determining the classification result RES_CLASS includes a sub-step S30_B of identifying at least one intruder alarm A_INTRU in the cluster C[k] considered during the execution of said step S30.

Thus, the classification result RES_CLASS obtained at the output of step S30 corresponds to the intruder alarms A_INTRU identified, where applicable, in the cluster C[k], which therefore constitutes the indication that said cluster C[k] is invalid.

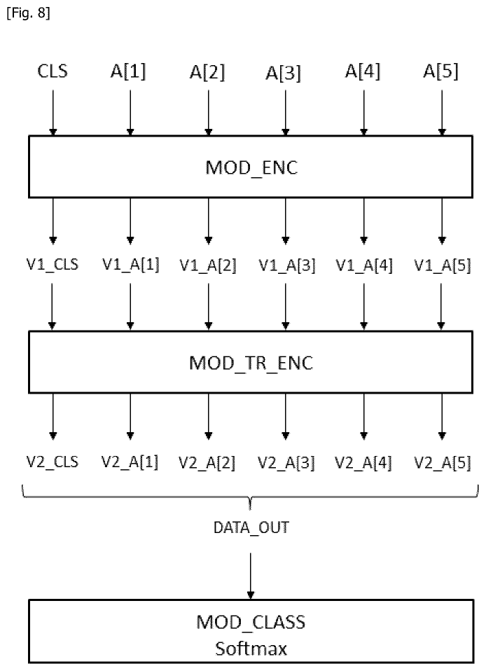

FIG. 8 schematically represents one example of configuration of the AI model for the implementation of the particular mode B.

Similarly to what was described above for FIG. 6, the example of FIG. 8 is such that:
a cluster C[k] is considered including five alarms A[1], . . . , A[5] provided as input to the AI model for the execution of steps S10, S20 and S30;
a classify token “CLS” is also provided as input to the AI model;
the encoding module MOD_ENC determines for each alarm A[i] a first vector representation V1_A[i], but also a first vector representation V1_CLS for the classify token CLS;
the transformer-encoder MOD_TR_ENC determines, for each of said first vector representations V1_A[i], V1_CLS, second vector representations V2_A[i], V2_CLS.

Subsequently, in the example of FIG. 8, said at least one output data DATA_OUT provided as output from the transformer-encoder MOD_TR_ENC corresponds to said second vector representations V2_A[i], V2_CLS.

These output data DATA_OUT are provided as input to the classification head MOD_CLASS which, in the example of FIG. 8, is a module implementing a normalized exponential function (also called “Softmax” function) so as to provide a probability for each of the alarms A[i] and for the classify token CLS. The element with the highest probability is therefore considered to be an intruder alarm, it being understood that if there is no intruder alarm, it is the classify token CLS that is assigned the highest probability.

It should be noted that, following considerations similar to those described above for the particular mode A, the use of the classify token CLS is not mandatory, and any other alternative known to those skilled in the art may be envisaged.

It should also be noted that, in the example of FIG. 8, only one intruder alarm is likely to be identified in a cluster C[k]. However, nothing precludes envisaging variants in which several intruder alarms may be identified. To do so, it is possible to envisage applying the identification sub-step S30_B iteratively for the same cluster C[k] by modifying the latter after each iteration to extract the identified intruder alarm therefrom. According to another alternative, it can be envisaged to train the classification head MOD_CLASS appropriately so that any intruder alarms contained in a cluster C[k] have significantly higher probabilities than the other alarms (so as to simplify their identification).

Regarding the training of the AI model within the framework of the particular mode B, the technical considerations described above within the framework of the particular mode A still apply. Additionally, a cross-entropy objective function (also called “cost function”) can be used to train the AI model to predict the position of the alarm with the highest probability among the sequence of alarms used as input.

Optionally, and as illustrated in FIG. 7, the processing method may also include a phase called “correction” phase if several clusters have been identified as invalid (i.e. if at least one intruder alarm has been detected in each among a plurality of clusters) at the end of steps S30 executed for each of the clusters C[1], . . . , C[K].

For the description of this correction phase, C[p]_F (p being an integer index comprised between 1 and P) denotes a cluster identified as invalid among the clusters C[1], . . . , C[K].

Therefore, said correction phase includes:
a step S40_B of updating the invalid clusters C[1]_F, . . . , C[P]_F by replacing, in each invalid cluster C[p]_F, at least one intruder alarm identified in said invalid cluster C[p]_F by at least one other intruder alarm identified in another invalid cluster C[p′]_F (p different from p′). This step S40_B is implemented by an update module MOD_UPD (not represented in the figures) equipping the device 100. Such an updated invalid cluster is denoted C[p]_F_NEW;
a step of executing, by the model AI, the classification phase for each of the updated clusters C[p]_F_NEW. In other words, the steps S10, S20 and S30 (and therefore also the sub-step S30_B in the present particular mode B) are executed for each of the updated clusters C[p]_F_NEW.

Said correction phase is iterated until a stopping criterion is satisfied. No limitation is attached to the nature of said stopping criterion. For example, this may correspond to the fact that there are no more invalid clusters. According to another example, the stopping criterion may correspond to a threshold not to be exceeded in terms of computation time.

### Particular Mode C

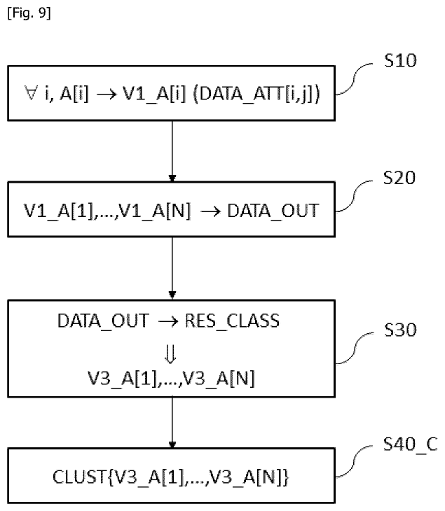

FIG. 9 represents, in the form of a flowchart, the particular mode C of the processing method of FIG. 3.

In the particular mode C, it is considered that said at least one set of alarms C[k] consists of the single set of alarms C[0] corresponding to all the alarms emitted in the communication network for a determined duration.

Moreover, in the particular mode C, and similarly to what was described above for the particular mode B, it is considered that said at least one output data DATA_OUT of the transformer-encoder MOD_TR_ENC includes, for each first vector representation V1_A[i] of an alarm A[i], a second vector representation V2_A[i]. It should be noted that the implementation of the particular mode C does not use a classify token CLS.

Furthermore, in the particular mode C, the AI model was trained using a contrastive learning technique so that the classification result RES_CLASS includes, for each second vector representation V2_A[i], a third vector representation V3_A[i].

Due to the training carried out using a contrastive learning technique, said third vector representations V3_A[i] are representative of a similarity (correlation) of the alarms A[i] of said single set of alarms C[0] in the representation space SP_R (or the latent space SP_L in the case where an additional encoding of the “embedding” type is executed) associated with said first vector representations V1_A[i].

Conventionally, the contrastive learning allows training the AI model so that pairs of alarms called “positive” alarms (i.e., correlated alarms in the representation space SP_R, or the latent space SP_L in the case where an additional “embedding” type encoding is executed) are close in a projection space P_PROJ (the notion of “proximity” being defined by means of a distance in said projection space P_PROJ, for example a Euclidean distance). Conversely, pairs of alarms called “negative” alarms (i.e., alarms whose correlations are low in the representation space SP_R, or the latent space SP_L in the case where an additional “embedding” type encoding is executed) are distant in the projection space P_PROJ.

The similarity (correlation) between the alarms A[i] in the representation space SP_R (or in the latent space SP_L in the case where an additional encoding of the “embedding” type is executed) is therefore also transposed into the projection space P_PROJ by projection of said third vector representations V3_A[i]. Those skilled in the art know how to choose an appropriate dimension of the projection space P_PROJ. In general, the technical aspects relating to the implementation of training by contrastive learning are well known to those skilled in the art, and are therefore not further detailed here.

Optionally, and as illustrated in FIG. 9, the processing method further includes a step S40_C of grouping the alarms of said single set of alarms C[0] into clusters from said third vector representations V3_A[i]. This step S40_C is implemented by a grouping module MOD_CLUST (not represented in the figures) equipping the device 100.

Said step S40_C may be implemented using any grouping technique known to those skilled in the art, in particular any unsupervised grouping technique. For example, it may be a k-means technique or a DBSCAN (Density-Based Spatial Clustering of Applications with Noise) technique.

Unlike the clustering methods of the state of the art, the particular mode C allows taking into account the semantic links between the alarms A[i] in the representation space SP_R (or in the latent space SP_L in the case where an additional “embedding” type encoding is executed), these semantic links being based exclusively on the attribute data DATA_ATT[i,j] (and not on time data). This approach is advantageous because it facilitates the approximation (respectively the remoteness) of the semantically close (respectively semantically distant) alarms, which advantageously makes it easier to determine valid clusters.

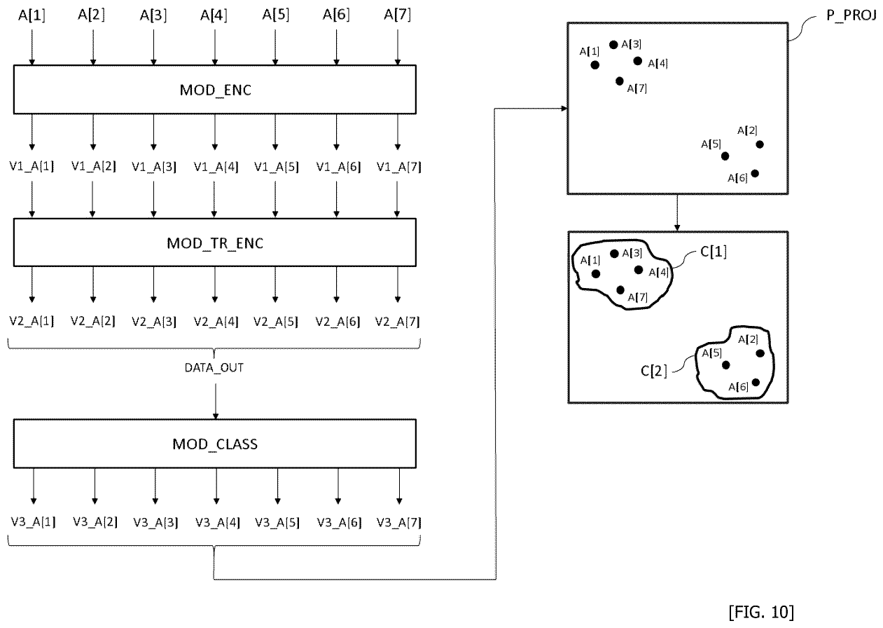

FIG. 10 schematically illustrates one example of grouping seven alarms A[1], . . . , A[7] using the particular mode C. In the example of FIG. 10, and for the sole purpose of simplifying the visual representation, it is considered that the second vector representations V2_A[1], . . . , V2_A[7] are projected into a two-dimensional projection space P_PROJ (i.e. a plane).

The resulting third vector representations V3_A[1], . . . , V3_A[7] are represented in the plane P using the references A[1], . . . , A[7] to which they are respectively associated, again for reasons of visual simplification.

As can be seen from FIG. 10, the alarms A[1], A[3], A[4] and A[7] form a first group of alarms close to each other. Furthermore, the alarms A[2], A[5] and A[6] form a second group of alarms close to each other, it being understood that the first and second groups are distant from each other.

Furthermore, in this example of FIG. 10, a k-means technique is applied to formally generate two clusters C[1] and C[2] respectively associated with said first and second groups of alarms. The root causes respectively associated with said clusters C[1] and C[2] are distinct.

The disclosed technology has been described so far by considering, via the particular modes B and C, the generation of valid clusters (the particular mode A being dedicated to the determination of the “valid” or “invalid” status of the clusters). However, the disclosed technology still covers embodiments in which, once valid clusters have been generated (regardless of the particular mode B or C used), a step of determining the root cause associated with said valid cluster is implemented for each of said generated valid clusters. Such a root cause determination step may be implemented according to any method known to those skilled in the art.

1. A method for processing at least one set of alarms emitted in a communication network, each alarm including at least one attribute data distinct from a time data, said method including, for each set of alarms, a classification phase comprising steps implemented by a trained machine learning AI model, including:
determining, for each alarm of said at least one set of alarms, and by an encoding module of the AI model, a first vector representation encoding said at least one attribute data, so as to obtain a set of first vector representations,
determining, from said set of first vector representations and by a transformer-encoder of the AI model, at least one second vector representation for each first vector representation, and
determining, from said at least one second vector representation and by a classification head of the AI model, a classification result of said set of alarms.

2. The method of claim 1, wherein said at least one attribute data includes one or more attribute data among:
a type of the alarm,
an indicator representative a severity level of the alarm,
a type of communication network entity that emitted the alarm,
an identifier of a communication network entity that emitted the alarm, and
an indicator representative of a network layer from which the alarm was emitted.

3. The method of claim 1, wherein:
said at least one set of alarms includes a plurality of sets of alarms, each set of alarms corresponding to a cluster having been generated prior to the implementation of the method from a superset of alarms emitted in at least part of the communication network during a determined duration, and each cluster being associated with an alarm corresponding to an event in the communication network at an origin of the emission of the alarms of said cluster, and
the classification result corresponds to an indication of validity or absence of validity of said cluster, which is determined by the implementation of the classification phase for each cluster, the absence of validity being defined by a presence in said cluster of at least one intruder alarm, and/or an absence in said cluster of at least one expected alarm.

4. The method of claim 3, wherein said indication of validity or absence of validity of said cluster is a binary classification result.

5. The method of claim 3, wherein the determination of the classification result includes an identification of at least one intruder alarm in said cluster.

6. The method of claim 5, said method further including, in response to detection of at least one intruder alarm in each among a plurality of clusters, a correction phase comprising steps of:
updating the invalid clusters by replacing, in each invalid cluster, at least one intruder alarm identified in said invalid cluster with at least one other intruder alarm identified in another invalid cluster, and
executing, by the AI model, the classification phase for each of the updated clusters,
said correction phase being iterated until a stopping criterion is satisfied.

7. The method of claim 3, wherein the AI model was trained using a masked language learning technique.

8. The method of claim 1, wherein:
said at least one set of alarms consists of a single set of alarms corresponding to alarms emitted in at least part of the communication network for a determined duration, said at least one output data of the transformer-encoder includes, for each first vector representation, a second contextualized vector representation, and
the AI model has been trained using a contrastive learning technique so that the classification result includes, for each second vector representation, a third vector representation, said third vector representations being representative of a similarity of the alarms of said single set of alarms.

9. The method of claim 8, said method further including a step of grouping the alarms of said single set of alarms into clusters from said third vector representations.

10. The method of claim 6, said method further including:
once the correction phase is completed and for each updated cluster, a step of determining an alarm belonging to said cluster and corresponding to an event in the communication network at the origin of the emission of the other alarms of said cluster.

11. The method of claim 7, wherein the AI model was trained using a masked language learning technique, said method further including:
once the correction phase is completed and for each updated cluster, a step of determining an alarm belonging to said cluster and corresponding to an event in the communication network at the origin of the emission of the other alarms of said cluster.

12. The method of claim 9, said method further including:
once the grouping step is completed and for each cluster, a step of determining an alarm corresponding to an event in the communication network at the origin of the emission of the alarms of said cluster.

13. The method of claim 1, wherein the communication network is an optical communication network or a CAN-type network deployed in a transport vehicle.

14. A non-transitory computer readable storage medium having stored thereon instructions which, when executed by a processor, cause the processor to implement the processing method of claim 1.

15. A device for processing at least one set of alarm messages emitted in a communication network, the device comprising a processor and a memory, each alarm message including at least one information characteristic of the alarm associated with said alarm message, said processing device configured to implement the processing method of claim 1.
